(19) United States
(12) Patent Application Publication
(10) Pub. No.: US 2018/0268351 A1
(43) Pub. Date: Sep. 20, 2018

(54) SYSTEM AND METHOD FOR ASSIGNING LOGISTIC ORDER TO CONSIGNOR BASED ON REVERSE BIDDING

(71) Applicant: Genex Science and Technologies Pvt. Ltd., Mumbai (IN)

(72) Inventor: Anil Jain, Mumbai (IN)

(21) Appl. No.: 15/590,044

(22) Filed: May 9, 2017

(30) Foreign Application Priority Data
Mar. 20, 2017 (IN) 201721009652

(51) Int. Cl. G06Q 10/08; G06Q 10/06

(52) U.S. Cl. CPC G06Q 10/083; G06Q 10/06313; G06Q 10/06311; G06Q 10/06312; G06Q 10/06315

(57) ABSTRACT

An end to end system and method for processing and assigning logistic order entered by consignor to a channel partner based on reverse bidding is disclosed. The method may comprise receiving a bid comprising an initial bid amount from each of the one or more channel partner to execute the one or more logistic orders. The method may further comprise assigning an initial score to each of the one or more channel partner based upon the initial bid amount in the bid and a time of bidding by each of the one or more channel partners. The method may further comprise updating the initial bid amount to a revised bid amount in the bid of each of the based upon predefined set of rules.

### CROSS-REFERENCE TO RELATED APPLICATIONS AND PRIORITY

The present application does claim priority from the Indian patent application number 201721009652 filed on Mar. 20, 2017.

### TECHNICAL FIELD

The present subject matter described herein, in general, relates to a field of transportation of goods and logistics, more particularly, relates to assignment of logistic order of a consignor to a channel partner based on reverse bidding.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Logistics primarily comprise of commercial activities of transporting goods of the consignors which form a major part of supply chain management. Logistics is a complex operation involving multiple activities including, but not limited to, organizing, planning, management and arrangement, administration, engineering, coordinating, handling and accomplishing the order.

Due to complex structure of working, many activities related to the logistics are often mismanaged due to time, location, risk mitigation and inventory related dependency.

Logistics, in general, is all about transporting and delivering the right product in the right quantity to the right place and at right time. Many a times channel partner are not conveyed to carry out pick-up points at right times or they aren't aware of the delivery of any shipment at a particular time or pick up at a particular place due to many human errors and human intervention. This irregularity may largely affect the shipments comprising transport of dry ice, ice, liquefied gases which require special environmental condition and the like.

Yet another major issue relating to the logistics is the confirmation of any shipment between a plurality of consignors and plurality of channel partner. Such confirmation of shipments may include human interference resulting in partiality for providing orders to the channel partner further providing unreasonable shipping costs to the consignors. There is a long-standing need to eradicate monopoly in bidding process in large number of shipment activities to manage suppliers of service or channel partner for maintaining a healthy relationship.

Yet another problem the logistic entity facing is the storage and warehousing related activities of inventory, further maintaining safety and quality. Apart having a large number of shipping docks, the channel partners are not aware of the availability of space at a particular dock. A real time informative system is required to eliminate such problem.

Therefore, there is a long-standing need for a system and method for assigning logistic order of consignor based on reverse bidding and further providing compliance to the participating entities in order to accomplish the logistic orders.

### SUMMARY

This summary is provided to introduce concepts related to system and method for assigning logistic order of consignor to a channel partner based on reverse bidding and the concepts are further described below in the detailed description. This summary is not intended to identify essential features of the claimed subject matter nor is it intended for use in determining or limiting the scope of the claimed subject matter.

In an implementation, a method for assigning logistic orders of a consignor to a channel partner for transferring a load associated to the logistic orders from the consignor to a consignee is described. The method may comprise registering a plurality of consignors, a plurality of consignees and a plurality of channel partners in a memory of a system. The method may further comprise receiving one or more logistic orders along with metadata associated with the one or more logistic orders of a consignor. The method may further comprise notifying the one or more logistic orders to one or more channel partners matching with the metadata associated with the one or more logistic orders. The method may further comprise receiving a bid comprising an initial bid amount from each of the one or more channel partners to execute the one or more logistic orders. The method may further comprise assigning an initial score to each of the one or more channel partners based upon the initial bid amount in the bid and a time of bidding by each of the one or more channel partners. The method may further comprise updating the initial bid amount to a revised bid amount in the bid of each of the based upon predefined set of rules. The method may further comprise modifying the initial score of each of the one or more channel partners to a final score based upon the revised bid amount. The method may further comprise sorting the one or more channel partners in an order of the final score assigned to each of the one or more channel partners. The method may further comprise displaying bid details associated with each of the one or more channel partner in the sorted order, wherein the bid details comprises a channel partner, the final score and the revised bid amount. The method may further comprise assigning a channel partner based on descending order of the final score for executing the one or more logistic orders.

In another implementation, a system for assigning logistic orders of a consignor to a channel partner to transfer a load associated to the order from a consignor to a consignee is described. The system may further comprise a processor and a memory coupled with the processor, wherein the processor executes a plurality of modules stored in the memory. The plurality of modules may further comprise a registering module configured for registering of a plurality of consignors, a plurality of consignees and a plurality of channel partners in the memory of the system. The plurality of modules may further comprise a logistic order placing module configured for placing one or more logistic orders along with metadata associated with the one or more logistic orders from a consignor. The plurality of modules may further comprise a notifying module configured for notifying the one or more logistic orders to one or more channel partners matching with the metadata associated with the one or more logistic orders. The plurality of modules may further comprise a bidding module configured for receiving a bid comprising an initial bid amount from each of the one or more channel partners to execute the one or more logistic orders. The plurality of modules may further comprise a bid analysing module configured for assigning an initial score to each of the one or more channel partners based upon the initial bid amount in the bid and a time of bidding by each of the one or more channel partners. The bid analysing module may be further configured for updating the initial bid amount to a revised bid amount in the bid of each of the based upon predefined set of rules. The bid analysing module may be further configured for modifying the initial score of each of the one or more channel partners to a final score based upon the revised bid amount. The bid analysing module may be further configured for sorting, via the processor, the one or more channel partner in an order of the final score assigned to each of the one or more channel partner. The bid analysing module may be further configured for displaying bid details associated with each of the one or more channel partners in the sorted order, wherein the bid details comprises a channel partner, the final score and the revised bid amount. The plurality of modules may further comprise an assigning module configured for assigning a channel partner based on descending order of the final score for executing the one or more logistic orders.

In yet another implementation, a non-transitory computer readable medium storing program for assigning logistic orders of a consignor to a channel partner to transfer a load associated to the order from a consignor to a consignee is described. The program may further comprise instructions for registering a plurality of consignors, a plurality of consignees and a plurality of channel partners in a memory of a system. The program may further comprise instructions for receiving one or more logistic orders along with metadata associated with the one or more logistic orders from a consignor. The program may further comprise instructions for notifying the one or more logistic orders to one or more channel partners matching with the metadata associated with the one or more logistic orders. The program may further comprise instructions for receiving a bid comprising an initial bid amount from each of the one or more channel partners to execute the one or more logistic orders. The program may further comprise instructions for assigning an initial score to each of the one or more channel partners based upon the initial bid amount in the bid and a time of bidding by each of the one or more channel partners. The program may further comprise instructions for updating the initial bid amount to a revised bid amount in the bid of each of the based upon predefined set of rules. The program may further comprise instructions for modifying the initial score of each of the one or more channel partner to a final score based upon the revised bid amount. The program may further comprise instructions for sorting the one or more channel partners in an order of the final score assigned to each of the one or more channel partners. The program may further comprise instructions for displaying bid details associated with each of the one or more channel partner in the sorted order, wherein the bid details comprises a channel partner, the final score and the revised bid amount. The program may further comprise instructions for assigning a channel partner based on descending order of the final score for executing the one or more logistic orders.

### Objects of the Invention

A primary object of the invention is to assign logistic orders of a consignor to a channel partner for transferring a load associated to the logistic orders from the consignor to a consignee/consignee.

Yet another object of the invention is to enable registration of a plurality of consignors, a plurality of consignees and a plurality of channel partners in a memory of a system.

Yet another object of the invention is to receive one or more logistic orders along with metadata associated with the one or more logistic orders from a consignor.

Yet another object of the invention is to notify the one or more logistic orders to one or more channel partners matching with the metadata associated with the one or more logistic orders.

Yet another object of the invention is to receive a bid comprising an initial bid amount from each of the one or more channel partners to execute the one or more logistic orders.

Yet another object of the invention is to assign an initial score to each of the one or more channel partners based upon the initial bid amount in the bid and a time of bidding by each of the one or more channel partners.

Yet another object of the invention is to update the initial bid amount to a revised bid amount in the bid of each of the based upon predefined set of rules.

Yet another object of the invention is to modify the initial score of each of the one or more channel partners to a final score based upon the revised bid amount.

Yet another object of the invention is to sort the one or more channel partners in an order of the final score assigned to each of the one or more channel partners.

Yet another object of the invention is to display bid details associated with each of the one or more channel partner in the sorted order, wherein the bid details comprises a channel partner, the final score and the revised bid amount.

Still another object of the invention is to assign a channel partner based on descending order of the final score for executing the one or more logistic orders.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a network implementation 100 of a server 101 facilitating assigning logistic order to consignor based on reverse bidding, in accordance with an embodiment of the present disclosure.

FIG. 2 illustrates components of the server 101, in accordance with an embodiment of the present disclosure.

FIG. 3 illustrates a method for assigning logistic order to consignor based on reverse bidding, in accordance with an embodiment of the present disclosure.

### DETAILED DESCRIPTION

The present invention in general relates to the field of supply chain management and more particularly relates to system and method for assigning logistic order to consignor based on reverse bidding.

For the purpose of this invention, “consignor” is an entity who places a logistic order for shipping its load. Consignor may comprise/shipper who wants to move their load to the consignee through truck, rail, air or sea mode.

For the purpose of this invention, “Consignee” is an Entity who can track consignment. Consignee may further comprise a company who will be receiving consignments sent by the consignor.

For the purpose of this invention, “Super Consignor/Booking Agents” is an entity who can place order on behalf of other consignors or can bid for the orders placed by other consignors and will place own or attached vehicles. Attached vehicles may comprise vehicles whose ownership is not with the Super Consignor/Booking Agent but has been taken from other channel partners for specific time period. The Super Consignor/Booking Agents may comprise logistics company who are transporters and will be providing transportation services to the consignor

For the purpose of this invention, “Channel Partner” may comprise fleet owners, transporter, associates or associates with attached vehicle and includes their drivers and vehicles. Fleet owners may be an entity who owns a vehicle, associate may be an entity who does not own any vehicle but place vehicle on behalf of fleet owner. The fleet owner may delegate authority to Associate with some type of physical contract. The associates with attached vehicles may be an entity who does not own any vehicle but manage vehicles of other fleet owners. The fleet owner may delegate authority to associate with some type of physical contract. The drivers of the vehicle may be equipped with smartphone, Global Positioning Device, prepaid card, diesel card and the like. Consignors and associates may be equipped with smartphone and prepaid card. Vehicles may be equipped with vehicle tracking system enabled by global positioning system and its hardware for tracking purpose.

For the purpose of this invention, user may comprise either of the consignor, consignee, channel partner, Super Consignor/Booking Agents and other personnel or entities who are involved in the logistic order.

For the purpose of this disclosure, a Business Development Executive (BDE) is a company employee who is registered in the server for processing the complete registration of all the stakeholders along with required forms. Such complete registration may be executed by a web application or web link which may direct to an online application present in the server. In an embodiment, the BDE or the BDE team may be responsible for the complete registration of the channel partner, vehicle, driver, primary transport centres and pick up points or locations and the like. The complete registration process may also comprise the roles of a checker and an approver whose roles are defined further.

For the purpose of this disclosure, the stakeholders may comprise the checker and the approvers which are the personnel employed for a plurality of reasons or tasks which are required to be checked and approved before finalisation. The task may comprise checking of mandatory documents or process as per the standards for procedure set by the stakeholder. It is to be noted that for a single task, a single person may not be employed as the checker as well as the approver. In an embodiment, the checker employed as a checker for task A may be employed as a checker for task B for which the checker is a different personal.

The present invention describes a system and method to assign a consignment of a consignor to a channel partner by way of reverse bidding. The reverse bidding is carried on a system with multiple bids received from the channel partners against the order of consignor. The present invention further describes the method of assigning the consignment order right from the consignment order query till the safe delivery of the consignment to consignee/consignees.

While aspects of described system and method for assigning logistic order to channel partner based on reverse bidding may be implemented in any number of different computing systems, environments, and/or configurations, the embodiments are described in the context of the following exemplary system.

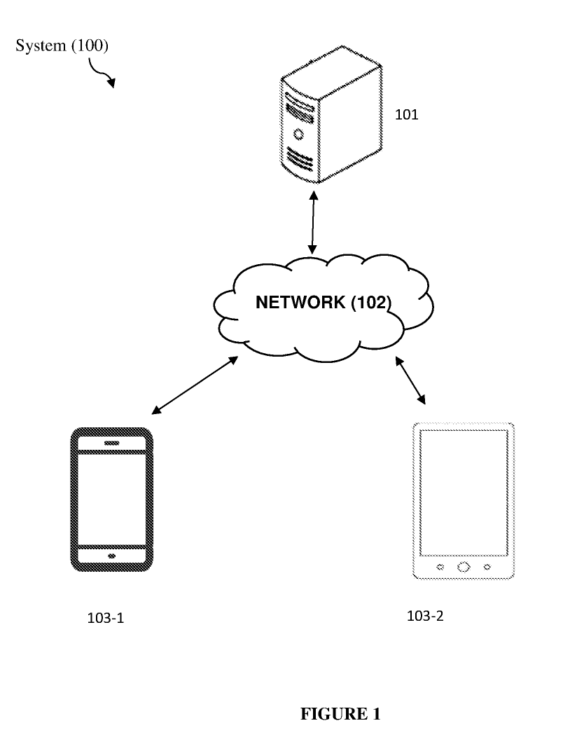

Referring to FIG. 1, a network implementation 100 of the server 101 for assigning logistic order to channel partner based on reverse bidding is illustrated, in accordance with an embodiment of the present subject matter. In one embodiment, the system 100 may comprise a server 101 which is configured for storing and processing the information. The server 101 may be accessed via a network 102 through the user devices 103. The user device 103 may be connected to the server 101 via the network 102. The server 101 may be accessed via the network 102 which may enable the user to sign in an account to produce a vehicle profile and a user profile. In an embodiment, the server 101 may comprise profiles belonging to a plurality of users further comprising consignor, consignee, channel partners, Super Consignor/Booking Agents and other personnel or entities who are involved in the logistic order and further to log in for updating the information relating to the bidding order, bidding process and consignment and the vehicle status from time to time. The servers 101 is further capable of accepting bids from one or more channel partners and further reconcile them using one or more operations explained further in order to assign the consignment to the deserved channel partner. The system 100 may carry reverse bidding/auction such that the bid value is given by the channel partner and further a plurality of bids associated with each channel partner are further given a score in decreasing amount as compared to the given bid value. In one embodiment, a score may be analogous to a rank or a level. The score may be assigned in form of characters or numerals or in alphanumeric form.

Although the present subject matter is explained considering that the system 100 is implemented on a server 101, it may be understood that the system 100 may also be implemented in a variety of computing systems, such as a laptop computer, a desktop computer, a notebook, a workstation, a mainframe computer, a server, a network server, a data centre and the like. It will be understood that the server 101 may be accessed by multiple users through one or more user devices 103-1, 103-2 . . . 103-N, collectively referred to as user 103 hereinafter, or applications residing on the user devices 101. Examples of the user devices 103 may include, but are not limited to, a portable computer, a personal digital assistant, a handheld device and a workstation. The user devices 103 are communicatively coupled to the system 101 through a network 102.

In one implementation, the network may be a wireless network, a wired network or a combination thereof. The network can be implemented as one of the different types of networks, such as intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

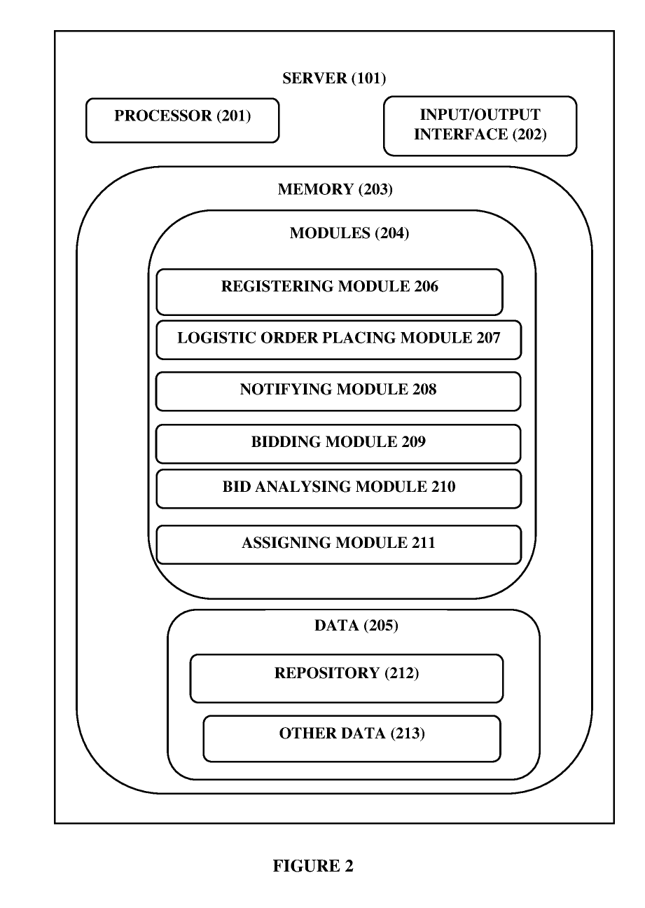

Referring now to FIG. 2, the server 101 is illustrated in accordance with an embodiment of the present subject matter. In one embodiment, the server 101 may include at least one processor 201, an input/output (I/O) interface 202, and a memory 203. The at least one processor 201 may be implemented as one or more microprocessors, microcomputers, microcontrollers, digital signal processors, central processing units, state machines, logic circuitries, and/or any devices that manipulate signals based on operational instructions. Among other capabilities, the at least one processor 201 is configured to fetch and execute computer-readable instructions stored in the memory 203.

The I/O interface 202 may include a variety of software and hardware interfaces, for example, a web interface, a graphical user interface, and the like. The I/O interface 202 may allow the system 100 to interact with a user directly or through the user devices 101. Further, the I/O interface 202 may enable the system 100 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting several devices to one another or to another server.

The memory 203 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks and magnetic tapes. The memory 203 may include modules 204 and data 205.

The modules 204 include routines, programs, objects, components, data structures, etc., which perform particular tasks or implement particular abstract data types. In one implementation, the modules 204 may include a registering module 206, a logistic order placing module 207, a notifying module 208, a bidding module 209, a bid analysing module 210 and an assigning module 211 and other modules (not shown). The other modules may include programs or coded instructions that supplement applications and functions of the system 100.

The data 205, amongst other things, serves as a repository for storing data processed, received, and generated by one or more of the modules 204. The data 205 may include data repository 210 and other data 213. The other data 213 may include data generated as a result of the execution of one or more modules in the other modules. The detailed functionality of the modules 204 are further described.

### Registering Module 206

The input/output interface 202 of the server 101 may enable a plurality of users to register themselves via a login system using a login form/online registration. The users may comprise a consignor, a channel partner, an associate and a driver. The user may also register their one or more vehicles which may be used for transport purpose.

In an embodiment, the process of registration is described as following:

For first time login, the user may be asked for registration with their subject for example as consignor, driver, channel partner, Marketing Intelligence Representative and the like. They may be prompted to enter their contact details comprising e-mail ID and telephone numbers. The user may be further verified by a one-time password verification process. The system may later allow the user to change password and login ID later.

In case of registration of consignor, channel partner and associate the details of the documents and information comprising TIN No. of the company, CIN No., Details of complete address with pin code, service tax no., PAN No, Aadhar card, Cancelled cheque of bank of the customer and bank details may be requested to the user. The server may further prompt the user to provide further details of the company with their constitution, further comprising a HUF, Individual, Limited company, Partnership firm with Limited Liability Company, private limited company and sole proprietorship. The server may later prompt for formal requirements like photograph, uploading of certificates and documents and set the application for registration.

In case of registration of driver, the account generation process is similar to the process mentioned above except for the submission of document and furnishing information. The documents and information may further comprise driver's passport size photograph, PAN card details, Aadhar card, license details along with the license type (MCV or HCV), address proof and cancelled cheque from the driver's bank. In an embodiment, if the driver does not produce a PAN card, then the driver may be asked to sign a declaration in Form 60. The driver may be further asked to provide his nickname as the drivers are recognised by their nicknames. The driver is prompted by the system to provide the channel partner/fleet owner to which the driver belongs or is associated. After complete verification by CRM team, the system will assign a Stakeholder code for each of the different stakeholders (Consignor, Channel Partner, Associate, driver Vehicle, Business development executive, checker, approver etc.

In an embodiment, the server may also process the verification and approval of the Marketing Intelligence Representative (MIR) for discharging role of providing prevailing Market rates on different routes as required by the MIR post may be registered as an individual or an entity as per the registrant.

The MIR registration checking process is described as following:

The user as a checker may login through normal login process as described in the above embodiments. The checker may view list of all stakeholders profile list. The checker may check registration form and verify uploaded documents with physical document. Once all the details of a form are checked, verification is considered to be completed and it gets submitted for approval. 10. Checker's name and current date may be saved as checked by and checked on date.

The user as an approver may login through normal login process as described in the above embodiments. The approver may get a list of all stakeholders-registration forms that have been checked by Checker. Approver may fill in the all the required admin details for the stakeholders and save them. After rechecking all details approver may either approve or reject the registration. The approver may provide a reason if he as the approver rejects any registration forms.

After complete verification process and without any legal problems, the registration is accomplished by submission of required documents comprising the certificates and other documents for verification.

In an embodiment, the documents for verification in case of vehicle registration may comprise registration certificate book of vehicle, pollution unit control, type of transport permit, insurance validity and vehicle fitness certificate. The required documents may be stored as a part of metadata mentioned in the repository 212. After completion of registration process, an extra layer of verification is made by a checker who checks the documents submitted by the user. Approval process may continue till all mandatory document checklist is updated. Every user will be allotted a code on approval of the registration. On approval of the form, stakeholder will get the access rights to the system as assigned to the user group. The approver's name and date will get saved as approved by and approved on date.

The Checker and Approver will always be different persons. Furthermore, the checker may be the approver for different registrations and the approver may be the checker for different registrations. The checker and approver may have interchangeable roles for different registrations but a checker is not an approver for a same registration.

In an exemplary embodiment, the field for MIR form is illustrated in the below mentioned table. In the table, fields with grey background represent master driven fields and fields in bold represent mandatory for filling.

| | | | | | | Check | Check |
|---|---|---|---|---|---|---|---|
| | Field | Field | | | | box for | box for |
| Image | # | details | Values | Master | Remarks | checker | approver |
| Web Interface for profile registration completion by MIR | | | | | | | |
| Company Information | | | | | | | |
| | 1 | Registration | Display | Unique | | | |
| | | Form no. | | | | | |
| | 2 | MIR Code | Display | Unique | 8 digit | | |
| | | (auto | after | | starting | | |
| | | generated) | approval | | with | | |
| | | | | | 6000000 | | |
| | | | | | server | | |
| | | | | | will | | |
| | | | | | confirm | | |
| | | | | | with sub- | | |
| | | | | | sytem | | |
| | | BDE | dropdown | Employee | Select | | |
| | | Executive | | | employee | | |
| | | | | | with role | | |
| | | | | | BDE | | |
| | 3 | Company | | | Associate | Y | Y |
| | | Name | | | | | |
| | 4 | Constitution | | Constitution | Applicable | | |
| | | (Type Of | | | if Pvt. | | |
| | | Company) | | | or Ltd | | |
| | | | | | or LLP | | |
| Upload | 5 | PAN number | alphanumeric | | 10 | Y | Y |
| | | | | | characters | | |
| | 6 | Service Tax | | | 15 | Y | Y |
| | | number | | | characters | | |
| | | | | | alphanumeric | | |
| upload | 7 | Address | | | Upload | Y | Y |
| | | | | | address | | |
| | | | | | proof | | |
| | | | | | mandatory | | |
| | 8 | Address line 2 | | | No | | |
| | | | | | validation | | |
| | 9 | State | | State | From | Y | Y |
| | | | | | master | | |
| | 10 | City | | City | From | Y | Y |
| | | | | | master | | |
| | 11 | Pin Code | | | 6 digit, | Y | Y |
| | | | | | all 0's not | | |
| | | | | | allowed | | |
| | 12 | District | | | | | |
| | 13 | Taluka | | | | | |
| | 14 | TDS | | | Yes/No. | | |
| | | Exemption | | | Attach | | |
| | | | | | Detail or | | |
| | | | | | Form | | |
| | | | | | 15G. | | |
| | 15 | Zone | | Zone | From | | |
| | | | | | master | | |
| | 16 | E-mail | | | No | | |
| | | address | | | validation | | |
| | 17 | Mobile No | | | 11 digits | Y | Y |
| | 18 | Land line No 1 | | | 11 digits | | |
| | 19 | Land line No 2 | | | 11 digits | | |

Transport Center

| | | | | | |
|---|---|---|---|---|---|
| 20 | Transport | TC1, | Select | Y | Y |
| | Center | TC2, | transport | | |
| | | TC3 | center for | | |
| | | | which | | |
| | | | rates will | | |
| | | | be asked. | | |

Bank Details

| | | | | | |
|---|---|---|---|---|---|
| | 21 | Name of | No | | |
| | | Bank | validation | | |
| | 22 | Address line 1 | No | | |
| | | | validation | | |
| | 23 | Address Line 2 | No | | |
| | | | validation | | |
| | 24 | Branch | No | | |
| | | | validation | | |
| | 25 | Account No | 12 to 17 | | |
| | | | digits | | |
| | 26 | State | From | | |
| | | | master | | |
| | 27 | City | From | | |
| | | | master | | |
| | 28 | Pin Code | 6 digit, | | |
| | | | all 0's not | | |
| | | | allowed | | |
| Upload | 29 | IFSC Code | Upload | Y | Y |
| | | | cancelled | | |
| | | | cheque | | |
| | | | copy | | |

Alternate Bank Details

| | | | | | |
|---|---|---|---|---|---|
| | 30 | Name of Bank | No | | |
| | | (Alternate) | validation | | |
| | 31 | Address line 1 | No | | |
| | | | validation | | |
| | 32 | Address line 2 | No | | |
| | | | validation | | |
| | 33 | Branch | No | | |
| | | | validation | | |
| | 34 | Account No | 12 to 17 | | |
| | | | digits | | |
| | 35 | State | From | | |
| | | | master | | |
| | 36 | City | From | | |
| | | | master | | |
| | 37 | Pin Code | 6 digit, | | |
| | | | all 0's not | | |
| | | | allowed | | |
| Upload | 38 | IFSC Code | Upload | Y | Y |
| | | | cancelled | | |
| | | | cheque | | |
| | | | copy | | |

Additional Details

| | | | | | | |
|---|---|---|---|---|---|---|
| Upload | 39 | GST number | | 15 digit | Y | Y |
| | | | | alphanumeric | | |
| | 40 | Type of | Full time/ | | | |
| | | Association | Part Time | | | |

REFERENCES (1)

| | | | | | |
|---|---|---|---|---|---|
| 41 | Name of | | | Y | Y |
| | Person | | | | |
| 42 | Address line 1 | | No | | |
| | | | validation | | |
| 43 | Address line 2 | | No | | |
| | | | validation | | |
| 44 | State | State | From | | |
| | | | master | | |
| 45 | City | City | From | | |
| | | | master | | |
| 46 | Pin Code | Pincode | 6 digit, | | |
| | | | all 0's not | | |
| | | | allowed | | |
| 47 | Mobile | | 10 digits | Y | Y |
| | Number | | | | |
| 48 | Email ID | | | Y | Y |

REFERENCES (2)

| | | | | | |
|---|---|---|---|---|---|
| 49 | Name of | | | Y | Y |
| | Person | | | | |
| 50 | Address line 1 | | No | | |
| | | | validation | | |
| 51 | Address line 2 | | No | | |
| | | | validation | | |
| 52 | State | State | From | | |
| | | | master | | |
| 53 | City | City | From | | |
| | | | master | | |
| 54 | Pin Code | Pin Code | 6 digit, | | |
| | | | all 0's not | | |
| | | | allowed | | |
| 55 | Mobile | | 10 digits | Y | Y |
| | Number | | | | |
| 56 | Email ID | | | Y | Y |

In an exemplary embodiment, the Admin Details to be filled in by Approver is illustrated in the below mentioned table.

| | | | | | |
|---|---|---|---|---|---|
| Image | Field # | Field details | Values | Master | Access rights |

Approval process
Operation Approval

| | | | |
|---|---|---|---|
| 1 | Operation | Location | |
| | location | | |
| 2 | Checked Flag | | |
| 3 | Checked By | | |
| 4 | Checked Date | | |
| 5 | Approved | | Admin Panel |
| | date | | |
| 6 | approved by | | |
| 7 | Accept/ | | |
| | Reject | | |
| 8 | Rejection | Reasons | |
| | Reason | master | |
| 9 | Reverification | | 1 year/2 year/3 |
| | Duration | | year |
| 10 | Reverification | | |
| | Date | | |
| 11 | Smartphone | | |
| | SIM Number | | |

Finance/Accounting approval

| | | | | |
|---|---|---|---|---|
| 12 | inco terms | (Freight | | Admin Panel |
| | | Prepaid/ | | |
| | | TBB/All) | | |
| 13 | Credit limit | | | 7/15/30/45/60/90 |
| 14 | Credit Limit | | | |
| | (in Rs) | | | |
| 15 | Blacklisted | | | |
| 16 | Active Flag | Y/N | | |
| 16 | Reconciliation | | COA | From FOCUS |
| | account code | | | |
| 17 | Sub group | | Vendor | |
| | code | | Sub group | |
| 18 | Group code | | Vendor | |
| | | | Group | |

### Logistic Order Placing Module 207

The logistic order placing module 207 may enable a consignor to place the logistic order. The logistic order can only be placed by a valid consignor and not by a blacklisted or inactive consignor. The valid consignor is allotted with a valid consignor code by the server 101. The logistic order may comprise parameters stored as a part of the metadata in the repository 212. The parameters of the logistic order may comprise description of load, vehicle capacity, loading and unloading points, vehicle type, base price for bidding process and permit type associated to the vehicle.

In an embodiment, the orders placed in a present session may be considered for processing for bidding in the next or upcoming session. For example, orders placed in the morning session may be considered for processing in the afternoon session or evening session.

In an exemplary embodiment, the metadata may further comprise:

1. Vehicle is not inactive or blacklisted

2. Vehicle documents are valid and the vehicle meets the order requirement.
i. All the documents whose expiry date/renewal is due in next 10 days/or as defined in parameter file will not be allowed to participate in bidding.
ii. Vehicles satisfying requirements of the order (documented in bidding process document)
iii. The vehicle will be checked for following documents expiry dates:
   1. RC book
   2. Vehicle fitness certificate
   3. PUC
   4. Permit.
   5. Insurance validity/renewal.
      The expiry dates should not be <10 days from current date. (The expiry date reminder shall be set as a parameter in the system 100.)

3. The channel partner must bid at least once for a load for any order/vehicle in one of the four consecutive eligible cycles. In case the channel partner does not bid in anyone of the four cycles, it will be presumed by the server 101 that either the vehicle is not available or channel partner is not interested in the particular sectors. It will then not be considered for the bidding cycle for that day. The following day the channel partner will be allowed to participate in the bidding cycle.

4. Day definition: A day may have two or more bidding cycles in a day. In case there are only two bidding cycles in a day the count of over will be rolled over to the next day.

### Notifying Module 208

The notifying module 208 may enable the server 101 for notifying one or more channel partners matching with the metadata associated with the one or more logistic orders. The fleet owner or his associate may receive notification by SMS/E-mail before pre-defined time of the commencement of the bidding process. The pre-defined time may range from 5 minutes to 30 minutes. The server 101 may display orders to the channel partner based on the matching of the metadata, capacity of load (in tonnes or Kg), dimensions of the container and the like.

The channel partner after receival of such notice may send one or more bids to operate a reverse bidding process or a reverse auction. In such reverse bidding, the consignors provide a valid and feasible amount for which the consignor is willing to pay on which the plurality of channel partner may provide a lower bid amount as compared to the bid amount provided by the consignor.

### Bidding Module 209

The bidding module may enable the system 100 to process the bids on receiving a plurality of bid amounts from the channel partner.

Before initiating the bidding process, the system 100 may verify a plurality of parameters for the eligibility of a channel partner in order to complete a consignment. The plurality of parameters for the eligibility of the channel partner is described in the method illustration of the present subject matter.

After filtering of the channel partners, the bidding module 209 may enable the system 100 to display a list of empty vehicles of the eligible channel partner with the following details:
i. Vehicle Number
ii. Capacity of the vehicle.
iii. Permit Type comprising national permit, state permit or any other required permit.
iv. Location of vehicle to nearest Transport Centre defined in system 100

The system 100 will filter the available orders in the following priority based on channel partner's eligible vehicles:
i. PTC (Primary Transport Centre)
ii. Type and subtype of vehicle available and vehicle mentioned in order placement.
iii. Category and Sub-category of material
iv. Type of Permit of Vehicle (comprising national permit, state permit or any other required permit)

After filtering, only the relevant order list will be shown to the channel partner or the Fleet Owner/Associate as shown in the screens below along with a timer displaying the time remaining for the bidding process.

The complete order may be viewed by selecting the order number in the list. The view option will display only certain relevant fields necessary for channel partner.

The bidding module 208 may further enable the system 100 to receive a bid comprising an initial bid amount from each of the one or more channel partner to execute the one or more logistic orders. In some embodiments, the channel providers who cannot participate in the scheduled bidding may be enabled to bid prior to the bidding by providing their bid amount to the system 100 by logging into the system 100 at any or a predefined time configured in the system 100. The bid amounts provided by these channel partners may be considered during the scheduled bidding process. For example, for the next day bidding scheduled at a time slot of 11 and 12 pm, the channel partners unavailable for the said time slot may be enabled to provide their respective bid amounts before two hours from the start of the bidding process (i.e. before 10 am).

### Bid Analysing Module 210

The bid analysing module 210 may further enable the system 100 to assign an initial score to each of the one or more channel partners based upon the initial bid amount in the bid and a time of bidding by each of the one or more channel partners. The bid analysing module 210 may further update the initial bid amount to a revised bid amount in the bid of each of the channel partner based upon predefined set of rules an initial score will be assigned to the plurality of channel partners. The bid analysing module 210 may further modify the initial score of each of the one or more channel partner to a final score based upon the revised bid amount. The bid analysing module 210 may further sort the one or more channel partners in an order of the final score assigned to each of the one or more channel partners. The bid analysing module 210 may display bid details associated with each of the one or more channel partners in the sorted order, wherein the bid details comprises a channel partner, the final score and the revised bid amount.

In an exemplary embodiment, the server 101 will then recalculate the scoring of the channel partner using the following method:
Save the original bid amount and score.
Compare the original score (ORL) L1 and L2 and check whether they are dedicated or part time channel partners/Associates. Give a higher priority to dedicated channel partner/associates, i.e. their score will become higher. Similarly compare all consecutive biddings.
Once again compare all consecutive biddings for their ratings and recalculate the bid amount as explained below:
   1. Assign a value of Rs 100 per star for the channel partner's rating.
   2. From the Bid Amount of the channel partner, subtract Rs·100/− per star (or a suitable amount as defined in parameter file) to arrive at an Effective Bid Amount (EBA) of the channel partner.
3. Now compare the Effective Bid Amounts (EBA) and time to get the Effective score) L1, L2, L3 and so on.
4. Display only the recalculated Effective score to the channel partner/associate on the bidding screen.

The score may be displayed on the basis of the final score. The page will be refreshed every 15 seconds to allow channel partners and associates to be updated with their latest score in each location. This frequency of refreshing page shall be set as a parameter and be subject to change. The channel partner may bid on all the available orders any number of times during the bidding window. The bidding duration can be changed and will be as specified in the bidding cycle definition table. The system may further assign a channel partner having the descending order of final score for executing the one or more logistic orders.

### Assigning Module 211

The assigning module 211 may enable the system 100 to assign a channel partner having the highest final score for executing the one or more logistic orders. The channel partner based on their final bid value will be scored as L1, L2, L3 and so on. The channel partner with lowest bid amount and other parameters such as the Channel Partners overall rating as defined in system will be assigned with as score as L1 and thereon the L2, L3 will be assigned in the ascending order of the bid amount. The consignor will be asked to accept or reject the Offer given to him and on acceptance of the offer rate, the channel partner is informed of the confirmation by the consignor and is asked to confirm the vehicle placement. In an embodiment, on rejection by the consignor, the order will be treated as closed and the vehicle will be treated as empty and available for assignment to an alternate load. The same will be informed to the Fleet Owner/channel partner.

In one embodiment, the sorting of the vehicle may further comprise selection of vehicles based on the tonnage capacity with a range of −3 tonnage capacity to +2 tonnage capacity in consideration of the required tonnage capacity.

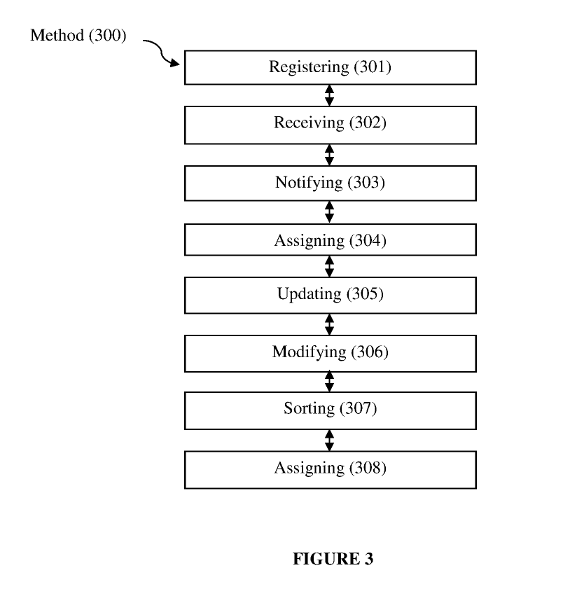

Referring FIG. 3, a method for assigning logistic order to channel partner based on reverse bidding is illustrated in accordance with an embodiment of the present subject matter.

At step 301, the registering of one or more users comprising the consignor, channel partner, consignee is executed via a sign up, login process verification and approval process

At step 302, one or more logistic orders along with metadata associated with the one or more logistic orders are received from a consignor. A consignor can place order at any point of time through web or mobile. Metadata may comprise permit type associated to the vehicle and the like. At least one consignor loading (pickup point) should be defined in the system 100 for the placing of an order. Order can be placed on weight basis or on volumetric basis (Load type). To start with, for sake of simplicity, the request for Vehicle/Order for Vehicle will be on Full truck Load basis. To facilitate quick data entry or order creation, the system 100 will bring forward last order details (irrespective of order status active for bidding/vehicle assigned/cancelled/in progress/closed/rejected). In case the order is a first-time order of the consignor, a blank screen may be displayed. The System 100 shall provide for an additional option of repeating an order in entirety through Order History. Thus, if a consignor has placed an order for a particular pick-up point and destination for a given Consignee and wishes to repeat this requirement, the system 100 will allow him to tick mark this order and thereafter system 100 will reproduce the entire order details, allow modifications such as date and time and assign it a new order no. The System 100 will allow him to mark orders one at a time and system 100 will thereafter reproduce all such orders and assign to each such repeat order a new order no. The consignor order or a set of consignor orders will be available for bidding for a specific time window (referred as a cycle). Order may be placed by Consignor for current date or for the next day or in advance also.

In an embodiment, the system 100 may consider for the bidding process orders placed in the pre-lunch slot as orders for pickup in the post lunch slot and will consider for the bidding process orders place order in the post lunch slot for pickup in the pre-lunch slot on next day. The no of bidding slots may be changed after doing pilot and obtaining feedback from concerned users.

The system 100 will consider all orders where pickup date is any date up to the next day's date i.e. past date, present date and next day's date with the condition that the order will be considered as forcefully closed after 48 hours from the first bidding cycle (currently refers to 4 bidding cycles) and will not thereafter taken for participate in the bidding process. In case no channel partner has placed bid for the consignor order then consignor order will be available for next window cycle for the bidding process. In case a consignor order has not been successfully closed, the consignor will be given a choice to carry forward the same and such orders will remain active and will be available for next 48 hours (2 days) for bidding. In an embodiment, Consignor order may lapse after 48 hrs. (2 days) and will not be available for the consignor thereafter. All such orders may be closed or cancelled at any time by consignor or by Back-office after obtaining confirmation from consignor. In case consignor rejects the system 100 provided offer price then order will be closed and will not be available for the next bidding. When a consignor rejects system 100 provided offer price, the system 100 will display a message that the order will be treated as closed. In an exemplary embodiment, in case a consignor does not either accept or reject an offer price, the system 100 will treat the order as closed after a lapse of one hour, the time offered to consignor. The System 100 may allow the consignor the facility to reactivate such a closed order. The System 100 may separately flag such orders so that they are available for re-activation. The reactivation may be allowed for 2 days after date of closure. In case consignor wishes to reactivate a closed order, consignor will be allowed to do by call/SMS/E-mail to the contact/help centre only.

At step 303, the one or more logistic orders are notified to one or more channel partners matching with the metadata associated with the one or more logistic orders, wherein the one or more predefined parameters comprises, permit type associated to the vehicle.

In an embodiment, an approved channel partner, who has been assigned a Vendor Code only will be allowed to participate in the bidding process. The channel partner may authorize an associate or his own staff who could be more than one in number to bid on his behalf. The channel partner or his associate or his staff may receive by SMS/E-Mail intimation of the bidding process at least 5 minutes before the commencement of the bidding process. The intimation period may be more than 5 minutes and shall be defined as a parameter in the system 100. The channel partner will be allowed to make their on-line bids through web-application or mobile app or registered mobile phone or through the call routing facility by calling. However, the system 100 may allow access to system 100 for bidding either through mobile app or Web application but not both concurrently. The facility to bid over phone shall be through authorised Team Leader/Operations Manager. Before accepting any bidding the concerned system 100 will authenticate the credential of the person calling which shall include one or more but not limited to the following factors:
Mobile contact Number
Pan Card Number
Date of Birth
System 100 will display orders matching the channel partner's vehicle type, subtype and transport centre in which vehicle is located. The current subtype field (text field) will be split up into 3 different fields as under:
   Description field (text)
   Capacity (in tons)
   Dimensions/length of container

At step 304, a bid comprising an initial bid amount is received from each of the one or more channel partners to execute the one or more logistic orders. The score of the channel partner will be based on the bid amount, part time/full time association with system 100, rating of the channel partner and bid date and time. The channel partner final rating shall be composite of the rating of driver by consignor, the rating of driver by consignor and rating of the channel partner by the system 100. Such composite rating shall include rating of the vehicle also. In case bid amount, association type and rating are same for more than one vehicle then vehicle with the earliest bid date and time will have higher score than the others. Channel partner can change the bidding amount till the bidding window is closed. Channel partner will be allowed to bid individually or collectively for each order to start with. Since the system 100 has already developed a Order-wise bidding process, the channel partner will be provided with an option to either bid by order or Bid by vehicle. The vehicle wise bidding process must keep this factor in mind while designing the system 100 and the database.

The system 100 may develop two business logics to allow vehicle wise bidding and order wise bidding at the choice and discretion of the channel partner but the channel partner or associate will not be allowed to alternate within a bidding cycle. In an embodiment, channel partner will either choose order wise bidding or vehicle wise bidding for a bidding cycle and not allowed to alternate within the bidding cycle. Once order bidding process window is closed, system 100 will internally process the orders and vehicles for the allocation of vehicle process based on predefined conditions. All things being equal, the vehicle which reported empty first will be given precedence.

At step 305, an initial score is assigned to each of the one or more channel partners based upon the initial bid amount in the bid and a time of bidding by each of the one or more channel partner.

In an embodiment, the channel partner may enter the number of vehicles to bid for a particular order and quote the bid amount per vehicle. The system 100 will then calculate the new score of the channel partner based on the bid amount as described under. System 100 will compare the bid amount and time and assign the scores for each bid as L1, L2, L3 and so on with L1 as the minimum amount bidding. This information will be saved as original bid amount and original level. This scoring will be done internally and only the latest score is displayed.

At step 306, 307 and 308, the initial bid amount is updated, modified and sorted to a revised bid amount in the bid of each of the channel partner based upon predefined set of rules. In an exemplary embodiment, the system 100 will then recalculate the scoring of the channel partner using the following method:
Save the original bid amount and score.
Compare the original score (ORL) L1 and L2 and check whether they are dedicated or part time channel partners/Associates. Give a higher priority to dedicated channel partner/associates, i.e. their score will become higher. Similarly compare all consecutive biddings.
Once again compare all consecutive biddings for their ratings and recalculate the bid amount as explained below:
   5. Assign a value of Rs 100 per star for the channel partner's rating.
   6. From the Bid Amount of the channel partner, subtract Rs·100/−per star (or a suitable amount as defined in parameter file) to arrive at an Effective Bid Amount (EBA) of the channel partner.
   7. Now compare the Effective Bid Amounts (EBA) and time to get the Effective score) L1, L2, L3 and so on.
   8. Display only the recalculated Effective score to the channel partner/associate on the bidding screen.

In an exemplary embodiment, a process is illustrated below from the notification of bidding to the finalisation of final score.

Vehicles Available for Bidding:

| Sr. | | | Vehicle | Distance | Capacity |
|---|---|---|---|---|---|
| No. | Vehicle No. | PTC | Location | (KM) | (MT.) |
| 1 | MH03 BG 5643 | Vapi | Daman | 10 | 7 |
| 2 | MH05 CA 1567 | Vapi | Chaar Rasta | 2 | 7 |
| 3 | GJ03 BA 5123 | Mumbai | Andheri | 14 | 15 |
| 4 | MH03 AC 7575 | Mumbai | Goregaon | 18 | 15 |
| 5 | HR03 MY 5643 | Mumbai | Chembur | 12 | 15 |

Data as Part of Bidding Screen:

Bidding by order
Time left: 25 Minutes
Note: Please click on order number to view order details

| Select Transport Centre | Vapi [symbol] |
|---|---|
| | Mumbai |

Bid time: 11.00 am 11.30 am Time left ( Minutes): (time counter)
PTC: Vapi Capacity: 7 tons

| | | | | | | | Bid for All | | |
|---|---|---|---|---|---|---|---|---|---|
| | | | | | Approx. | | No. | (Rate | |
| Sr. | Loading | | | Vehicle | Dist | | of | per | Enter |
| No. | Point | Destination | Material | Required | in km | Score | vehicles | Vehicle | Bid |
| 1 | Somnath, | Bangalore | Chemicals | 4 | 750 | L1 | 1 | 23000 | 22500 |
| | Daman | | | | | | | | |
| 2 | GIDC, | Mahad | Plastic | 8 | 500 | L4 | 1 | 16000 | 15500 |
| | Vapi | | Drums | | | | | | |
| 3 | Kachigaon, | Mahad | Plastic | 2 | 500 | | | | |
| | Daman | | Granules | | | | | | |

Submit

PTC: Mumbai Capacity: 15 tons

| | | | | | | | Bid for All | | |
|---|---|---|---|---|---|---|---|---|---|
| | | | | | Approx. | | No. | (Rate | |
| Sr. | Loading | | | Vehicle | Dist | | of | per | Enter |
| No. | Point | Destination | Material | Required | in km | Score | vehicles | Vehicle | Bid |
| 1 | Somnath, | Bangalore | Chemicals | 4 | 750 | L1 | 1 | 23000 | 22500 |
| | Daman | | | | | | | | |
| 2 | GIDC, | Mahad | Plastic | 8 | 500 | L4 | 1 | 16000 | 15500 |
| | Vapi | | Drums | | | | | | |
| 3 | Kachigaon, | Mahad | Plastic | 2 | 500 | | | | |
| | Daman | | Granules | | | | | | |

Submit

### Example

There are 2 channel partners who have quoted for route as under:

| Sr. | | | Original Bid Amount |
|---|---|---|---|
| Nos. | Score | Rating | (In Rs.) |
| 01. | L1 | 2 (**) | 12,600.00 |
| 02. | L2 | 3 (***) | 12,700.00 |

In the above Model L1 & L2 is based on the rate quoted by channel partner. However, weightage is to be given to their rating and score which works as under:
i) Assign a rating Value of Rs 100 per star (One star=Rs 100, 2 Star=Rs 200 etc.)
ii) In the above example L2 is rated as 3 star and L1 as 2 star, therefore the rating value is Rs 200 and Rs 300 respectively.
iii) From the Original Bid amount deduct the score to derive an Effective Bid Amount (EBA).
iv) Compare the Effective Bid Amount (EBA) to determine each bid's scoring.
v) In case the Effective Bid Amount (EBA) for two or more channel partner is the same, the channel partner with a higher score will qualify for a higher Effective score. If all parameters are equal, then the person who has bid first (in time) will qualify to have a higher scoring. Such a scoring which is based on effective score and time shall be called derived score. The derived score shall now be the basis of allocation of Vehicle. The derived score shall be for internal working only and not be displayed to the channel partner on the bidding screen.
vi) Based on the above, the process of internally determining Effective score (ERL) for bid amount shall be as under:

| | | | Original | Rating | Effective | |
|---|---|---|---|---|---|---|
| | | | Bid Amt. | Value at | Bid Amt. | |
| Sr. | | | (OBA | Rs 100 | (EBA | Effective |
| Nos. | Score | Rating | In Rs.) | per star | In Rs.) | score. |
| A | B | C | D | E | F = D − E | G |
| 01. | L1 | 2 (**) | 12,700.00 | 200 | 12,500.00 | L4 |
| 02. | L2 | 3 (***) | 12,600.00 | 300 | 12,300.00 | L2 |
| 03. | L3 | 3 (***) | 12700.00 | 300 | 12400.00 | L3 |
| 04. | L2 | 4 (****) | 12600.00 | 400 | 12200.00 | L1 |

In the bidding process, the score must be displayed on the basis of the final score. The page will be refreshed every 15 seconds to allow channel partners and associates to be updated with their latest score in each location. This frequency of refreshing page shall be set as a parameter and be subject to change. The channel partner may bid on all the available orders any number of times during the bidding window. The bidding duration can be changed and will be as specified in the bidding cycle definition table.

In an embodiment, 2 minutes before the end of bid session or as set in the parameter file, a message will be displayed as: “You have 2 minutes to finalize your bids.” and at end of the bid, display message. “We thank you for participating in the bid process.” In case there is no load available for any of the vehicles, then the system 100 will display a message as: “We regret, currently there are no loads available matching your vehicle requirements.” For the purpose of bidding the channel partner shall have option to bid Order wise or Vehicle wise. All such bids made either order wise or vehicle wise shall be processed in a common bucket and the scores shall be determined collectively for all orders whether bid for by Order or by vehicle. The Bidding screen for Vehicle wise bidding by channel partner/Associate/His staff shall be as under.

In yet another embodiment, a process for bidding by vehicle is illustrated in the following example.

Bidding by vehicle
Time left: 25 Minutes
Note: Please click on order number to view order details

| | | | | |
|---|---|---|---|---|
| Truck No. | MH03 | Vapi | Capacity | 7 Tons |
| | BG 5643 | | | |

Bid time: 11.00 am 11.30 am Time left ( Minutes): (time counter)
User ID:
PTC: Vapi Capacity: 7 tons

| | | | | | | | Bid for All | | |
|---|---|---|---|---|---|---|---|---|---|
| | | | | | Approx. | | No. | Bid | |
| Sr. | Loading | | | Vehicle | Dist | | of | per | Enter |
| No. | Point | Destination | Material | Required | in km | Score | vehicles | Vehicle | Bid |
| 1 | Somnath, | Bangalore | Chemicals | 4 | 750 | L1 | 1 | 23000 | 22500 |
| | Daman | | | | | | | | |
| 2 | GIDC, | Mahad | Plastic | 8 | 500 | L4 | 1 | 16000 | 15500 |
| | Vapi | | Drums | | | | | | |
| 3 | Kachigaon, | Mahad | Plastic | 2 | 500 | | | | |
| | Daman | | Granules | | | | | | |
| | | | | | | | | Submit | |
| Truck No. | MH05 | Mumbai | | Capacity | 15 | | | | |
| | CA | | | | Tons | | | | |
| | 1567 | | | | | | | | |
| | | | | | | | Bid for All | | |
| | | | | | Approx. | | No. | (Rate | |
| Sr. | Loading | | | Vehicle | Dist | | of | per | Enter |
| No. | Point | Destination | Material | Required | in km | Score | vehicles | Vehicle | Bid |
| 1 | Andheri | Bangalore | Chemicals | 8 | 930 | L1 | 1 | 20000 | 19500 |
| 2 | Dadar | Bangalore | Plastic | 6 | 950 | L2 | 1 | 21000 | 20500 |
| | | | Drums | | | | | | |
| 3 | Chembur | Vapi | Plastic | 12 | 195 | L1 | 1 | 20000 | 19500 |
| | | | Granules | | | | | | |

Submit

The allocation should be completed by order and by vehicle for the selected Primary Transport Centre (PTC) based on PTC locations of the vehicle.

An example is illustrated below as an embodiment of the present subject matter:

PTC: Ahmedabad

| Order | | No. |
|---|---|---|
| No. | Order Vehicle Type | Required |
| 01 | Taurus 15 MT (Open Top) | 1 No. |
| 02. | Taurus 16 MT (Open Top) | 1 No. |

Vehicle Available

L1—Taurus 16MT

L2—Taurus 16MT

In the above case system 100, will look for L1 rate for a particular route and then match to look vehicle sub type with equal to order sub type vehicle. In case vehicle is available, the system 100 will match the vehicle and mark off both the order and the vehicle. In case after the conclusion of all the bidding cycle of the day then any vehicle remains unassigned, the system 100 shall mark such vehicle as Idle Vehicle for Idle Vehicle Reimbursement Charge
i. In case two or more vehicles of a channel partner is L1, for any given destination, then the vehicle which has history (city and not exact consignee location) of having travelled on this route in the past shall be given preference.
ii. In case two or more vehicles have the same history of travelling on the route, then the vehicle with more no of trips shall be given precedence.
iii. In case two or more vehicles have same history and same no of trips, the vehicle with lower age (based on RC date) shall be given preference in the allocation of vehicle.
iv. If a channel partner is L1 for more than one destination (say 2) and similarly 2 vehicles for allocation, the system 100 shall allocate Vehicle as enumerated in points i to iii herein above.
v. In bidding process following persons can bid concurrently for customer order. Each of these persons will log in from a separate id.
   a) Channel partner
   b) Sub User (Representative of channel partner/Employee)
   c) Associates (Broker)
vi. The system 100 shall take into account the lowest bidding of the above 3 persons for the purpose of allocations of vehicles.
vii. For example let us consider the following as the final bids Consignor 1 No. of Vehicles Regd.—2 Nos.
   Vehicles Available channel partner 1=1
   Vehicles Available channel partner 2=1

| Sr. | | | | No. of Vehicles |
|---|---|---|---|---|
| Nos. | Persons | Bid Amount | Score | Bid |
| 01 | Channel Partner 1 | 10,000 | L1 | 1 |
| 02 | Channel Partner 2 | 10,100 | L2 | 1 |
| 03 | Sub User (channel | 10,200 | L3 | 1 |
| | partner) | | | |
| 04 | Associate (of | 10,300 | L4 | 1 |
| | channel partner) | | | |

| | |
|---|---|
| Total | 4 |

viii. For the purpose of allocations after completing the allocation of L1 (1 Vehicle offered by channel partner 1), the system 100 will take L2 rate and apply the same L2 rate for allocating vehicles offered by (channel partner and his representatives)
   Channel partner 2
   Sub User (Channel partner2)
   Associates (Channel partner2)

In an embodiment, a common rate will be applied to all persons/entities representing the same channel partner. The objective of the above allocations is to ensure that a consignor gets a common rate from the same channel partner and that all consignors get same rate from the concerned channel partner.

While determining the priority of offering vehicles to the consignor, the system 100 will take into account other parameters such as time of bidding, vehicle history, discount to consignor, consignor rating etc.
ix. In another example, consider the following:
   Consignor 1 No. of Vehicles Regd.—3 Nos.
   Vehicles Available Channel partner 1=1
   Vehicles Available Channel partner 2=3

| Sr. | | | | No. of Vehicles |
|---|---|---|---|---|
| No | Persons | Bid Amount | Score | Bid |
| 01 | Channel partner1 | 10,000 | L1 | 1 |
| 02 | Channel partner2 | 10,100 | L2 | 1 |
| 03 | Sub User (channel | 10,200 | L3 | 1 |
| | partner2) | | | |
| 04 | Associate (channel | 10,300 | L4 | 1 |
| | partner2) | | | |

| | |
|---|---|
| Total | 4 |

In the above e.g., the consignor will be offered 3 Vehicles at an average rate of L1+L2+System margin. The objective is to offer a common rate to the cosigner.
x. Another example is illustrated below.

Consignor 1 No. of Vehicles Regd.—2 Nos.

Consignor 2 No. of Vehicles Regd.—2 Nos.

Vehicles Available channel partner 1=1

Vehicles Available channel partner 2=4

| Sr. | | | | No. of Vehicles |
|---|---|---|---|---|
| Nos. | Persons | Bid Amount | Score | Bid |
| 02 | Channel partner 1 | 10,000 | L1 | 1 |
| 02 | Sub User (channel | 10,100 | L2 | 2 |
| | partner 1) | | | |
| 03 | Channel partner 1 | 10,200 | L3 | 1 |
| 04 | Associate (channel | 10,300 | L4 | 1 |
| | partner 1) | | | |

| | |
|---|---|
| Total | 5 |

In the above illustrated example consignor 1 will be offered 2 vehicles at an average rate of L1+L2+System margin. The objective is to offer a common rate to the cosigner 1.

Consignor 2 will be offered 2 vehicles at an average rate of L3+L4+System margin
xi. Consignor 1 No. of Vehicles Regd.—1 Nos.
   Consignor 2 No. of Vehicles Regd.—2 Nos.
   Vehicles Available channel partner 1=2
   Vehicles Available channel partner 2=4

| Sr. | | | | No. of Vehicles |
|---|---|---|---|---|
| Nos. | Persons | Bid Amount | Score | Bid |
| 01 | Channel partner 1 | 10,000 | L1 | 1 |
| 02 | Associate (Channel | 10,050 | L2 | 1 |
| | partner 1) | | | |
| 03 | Channel partner | 10,100 | L3 | 2 |
| | (Channel partner 2) | | | |
| 04 | Associate (Channel | 10,200 | L4 | 2 |
| | partner 2) | | | |
| 05 | Sub User (Channel | 10.250 | L5 | 2 |
| | partner 2) | | | |

| | |
|---|---|
| Total | 8 |

In the above example,

Consignor 1 will be offered 1 vehicle @Rs. 10,000 (L1)+system Margin (Rate of channel partner 1)

Consignor 2 will be offered 2 vehicles will be offered 2 vehicles at an average rate of L1+L2+System margin.
xii. Yet another example is illustrated wherein associate representing more than 1 channel partners)
   Consignor 1 No. of Vehicles Regd.—1 Nos.
      Consignor 2 No. of Vehicles Regd. 2 Nos.
      Vehicles Available Channel partner 1=1
      Vehicles Available Channel partner 2=4

| Sr. | | | | No. of Vehicles |
|---|---|---|---|---|
| Nos. | Persons | Bid Amount | Score | Bid |
| 01 | Associate (Channel | 10,000 | L1 | 2 |
| | partner 1 and | | | |
| | Channel partner 2) | | | |
| 02 | Channel partner 1 | 10,050 | L2 | 1 |
| 03 | Channel partner 2 | 10,100 | L3 | 2 |
| 04 | Sub User (Channel | 10.200 | L4 | 2 |
| | partner 2) | | | |
| 05 | | | | |

| | |
|---|---|
| Total | 7 |

In the above example,

Consignor 1 will be offered 1 vehicle @Rs. 10,000 (L1)+system Margin (Rate of Associate)

Consignor 2 will be offered 2 vehicles at an average rate of L1+L3+System margin

Allocation of Vehicle to Consignor Order

1. All Orders shall be assigned vehicle as explained in above.

2. In case the total Outstanding of Consignor plus the proposed allocation of

Vehicles exceed the Credit Limit amount of the Consignor, the system 100 shall not allocate a vehicle but send an alert to Consignor and CRM Team with the remarks. “Please clear your outstanding as the amount is exceeding your assigned credit limit. We regret our inability to provide Trucks to you at this juncture.” Any waiver to above shall be by Business Head and in his absence the CEO.

Rate Offered to Consignor:
1. Once the vehicles are assigned to the order, the consignor will be offered a rate per vehicle for the trip. The rate offered to the Consignor will depend on:
i. Channel partner Quote Amount
ii. Consignor Rating Based Margin and a system 100 based calculation of Discount.
iii. Market Rate
iv. Consignor Based Inconvenience Charges, if any (when channel partner cancels vehicle). The amount of inconvenience charges shall be set as a parameter.

The system 100 should be able to monitor standard transit time of all routes and in case due to any unforeseen development such as riots, floods etc., there is an increase in transit time of one day or more, then the system 100 should levy temporary route congestion @Rs·500/−per day. The amount to be levied shall be set as a parameter.

In case the transit time is restored to normal standard transit time, the system 100 should stop levying the route congestion charges.

2. The system 100 should run periodic update to determine actual transit time. The frequency of such update shall be either daily or once in 3 days. The period to run the update shall be set up as a parameter.
3. The Market Rate will be obtained from our Associate/Broker through the broker's app.
4. The final rate offered to Consignor will be calculated based on the Original Bid amount of the channel partner/Associate.
5. Additionally, the system 100 should provide an option of calculating Offer rate to consignor using the lowest of all the original bid amounts of all the vehicles assigned to the consignor.
6. The order requirement of a Consignor on a particular route is of 3 vehicles; the vehicles assigned

are V1 @ Rs·13250/−, V2 at Rs 13300 and V3 @ Rs·13350/−,
7. In the first option as mentioned above, the rate offered to the consignor shall be based on Original bid amount of channel partner+system 100's Margin (Less Discount if any). Thus, the system will have three different rates for each of the 3 vehicles (V1/V2/V3). However, for each of the vehicles (V1/V2/V3), average of the three different rates may be assigned so as to ensure that the customer/cosigner is offer with a single rate (average of V1, V2, V3) for a single vehicle on a same route.
8. In the additional option as outlined above, the system 100 will calculate the rate offered based on V1 @ 13250/−.

Considering the final amount (13250+system 100 margin) is Rs·16000/−, then the consignor will be offered Rs. 16000/− per vehicle for all 3 vehicles.

Margin Calculation:

The system 100 will first calculate the difference between the market rate and the channel partner's bid amount:

### Example 1

a) Market Rate 17,000.00
b) Channel partner's Rate (L1 Quote)—13,250.00

The system 100 will calculate the difference between the Market Rate and channel partner's Rate.

Market Rate−channel partner rate(L1)=Margin on Market Rate

i.e. 17000.00−13,250.00=3750.00

Gross Margin on Market Rate in %=3750/17000=22.05% (rounding off)=22%

In one example, the system 100 may consider 15% being the minimum margin for the system 100. However, the margin level is variable and is subject to change.

If gross margin on Market rate is below 15%, then the consignor will be offered rate as Consignor Rate Offered=Channel partner Rate+minimum margin as defined in system (15% as mentioned above). The calculation shall be based as under:

Channel partner Rate/85%=13250/85%=Rs15588(rounded to 15600/−)

In above example the channel partner Rate is 13250, Consignor Offer Rate is 15600 so margin is =Rs 2350.

So Margin %=2350/15600=15.06% (rounded to 15%). In other words, the margin is always on the Consignor Offer Rate.

Also, the net margin will be calculated with reference to the margin table as:

Net Margin=Gross Margin−Applicable discounts−Rating based Discount %

The Admin user of system will be provided a facility to manage the margin and discount structure through his login. A start date and end date will be defined for each margin structure. Any changes made will not be considered during the current bidding cycle and can be made effective only from the next bidding cycle.

Margin Structure (Based on a Minimum Margin of 15%):

| Gross | | | | | | | | | | | | |
|---|---|---|---|---|---|---|---|---|---|---|---|---|
| Margin | | | | | | | | | | | | |
| (%) | | Margin | Consignor Rating related | | | | | Net Margin after | | | | |
| (Market | Applicable | after | additional Discount | | | | | all Discounts | | | | |
| Rate − L1 | Discount | Discount | (%) | | | | | (%) | | | | |
| Rate) | (%) | (%) | 1* | 2* | 3* | 4* | 5* | 1* | 2* | 3* | 4* | 5* |
| 15 | 0 | 15 | 0 | 0 | 0 | 0 | 0 | 15 | 15 | 15 | 15 | 15 |
| 16 | 1.0 | 15 | 0 | 0 | 0 | 0 | 0 | 15 | 15 | 15 | 15 | 15 |
| 17 | 2.0 | 15 | 0 | 0 | 0 | 0 | 0 | 15 | 15 | 15 | 15 | 15 |
| 18 | 3.0 | 15 | 0 | 0 | 0 | 0 | 0 | 15 | 15 | 15 | 15 | 15 |
| 19 | 4.0 | 15 | 0 | 0 | 0 | 0 | 0 | 15 | 15 | 15 | 15 | 15 |
| 20 | 5.0 | 15 | 0 | 0 | 0 | 0 | 0 | 15 | 15 | 15 | 15 | 15 |
| 21 | 5.5 | 15.5 | 0 | 0 | 0 | 0 | 0 | 15.5 | 15.5 | 15.5 | 15.5 | 15.5 |
| 22 | 6.0 | 16 | 0 | 0 | 0 | 0.25 | 0.50 | 16 | 16 | 16 | 15.75 | 15.50 |
| 23 | 6.5 | 16.5 | 0 | 0 | 0 | 0.25 | 0.50 | 16.5 | 16.5 | 16.5 | 16.25 | 16 |
| 24 | 7.0 | 17 | 0 | 0 | 0.25 | 0.50 | 0.75 | 17 | 17 | 16.75 | 16.50 | 16.25 |
| 25 | 7.5 | 17.5 | 0 | 0 | 0.25 | 0.50 | 0.75 | 17.5 | 17.5 | 17.25 | 17 | 16.75 |

Note:
Default rating of consignor shall be ***(3) Star 0.50 + roundup. All fraction shall be rounded off to nearest integers and put rating of 0.50 shall be rounded up.

1. Based on above margin table, the rate offered based on 22% gross margin can be calculated as:
   i. One Star (*) Rating:

Channel partner rate+Net Margin=13250/(100−16%)=84%=15773
Rate Offered (Rounded off)=15800
ii. Two Star (**) Rating

Channel partner rate+Net Margin=13250/(100−16%=15773/−Rate Offered(Rounded off)=15800/−
iii. Three Star (***) Rating

Channel partner rate+Net Margin=13250/(100−16%)=15773/−
Rate Offered (Rounded off)=15800/−
iv. Four Star (****) Rating

Channel partner rate+Net Margin=13250/(100−15.75%=15727/−
Rate Offered (Rounded off)=15700/−
v. Five Star (*****) Rating

Channel partner rate+Net Margin=13250/(100−15.50%=15,680/−
Rate Offered (Rounded off)=15650/−

(All rounding off shall be done to the nearest multiple of Rs·50/−)

Summary of the above rating is given as below:

| Rating | Market Rate | Channel partner Rate | Offered Rate |
|---|---|---|---|
| One Star (*) | 17,000.00 | 13,250.00 | 15,800.00 |
| Two Star (**) | 17,000.00 | 13,250.00 | 15,800.00 |
| Three Star (***) | 17,000.00 | 13,250.00 | 15,800.00 |
| Four Star (****) | 17,000.00 | 13,250.00 | 15,700.00 |
| Five Star (*****) | 17,000.00 | 13,250.00 | 15,650.00 |

2. In case no market rate is available then system will calculate the offered rate as:

Consignor Offered Rate=Channel partner Rate+Minimum net margin (15%)

### Example

Channel partner Rate=13250/− and market rate is not available

Consignor offered rate=13250/(100−15%)=13250/85%=15588/−
Rate Offered (Rounded off)=15600/−

The minimum net margin will remain the same for all consignors irrespective of their rating.

The calculate rate is then offered to the consignor as the rate per vehicle against that order. The consignor will be asked to accept or reject the Offer given to him. On acceptance of the Offer Rate, the channel partner is informed of the confirmation by the consignor and is asked to confirm the vehicle placement. On rejection by the consignor, the order will be treated as closed and the vehicle will be treated as empty and available for assignment to an alternate load. The same will be informed to the Channel partner. Both the channel partner and the cosigner/customer may be notified via an email/SMS in order to confirm/accept the order/offer respectively.

In an embodiment, an order-vehicle assignment process is described. The allocation may be completed by order and by vehicle for the selected Primary Transport Centre (PTC) based on PTC locations of the vehicle.

The system may sort each order in a PTC based on descending order of distance i.e. longest distance orders will be assigned a vehicle first.

The system may then assign the vehicles of the channel partner at level L1 against each order one by one by matching the vehicle type and subtype mentioned in the order and vehicle. The system may also take into account the type of permit (National/State) and any route restrictions/confinement of routes on which the channel partner wishes to operate. These restrictions of routes shall be as mentioned in Vehicle Master.

The Allocation of vehicles may be executed in the following order wherein for the purpose of allocation of vehicles the following priority shall be taken into account. Allocation process is as followed:
By PTC
By matching capacity range
Higher Capacity Range
Lower Capacity Range
By bidding cycle (previous cycle to be given preference over current cycle)
By Rate (Freight amount)
First Bid Time
Route History
Age of Vehicle based on RC date

The allocation may be completed by order and by vehicle for the selected PTC based on PTC locations of the vehicle.

An example is illustrated below as an embodiment of the present subject matter:

Following are the order requirement

PTC: Ahmedabad

| Order | | No. |
|---|---|---|
| No. | Order Vehicle Type | Required |
| 01 | Taurus 15 MT (Open Top) | 1 No. |
| 02. | Taurus 16 MT (Open Top) | 1 No. |

Vehicle available in the PTC are:

L1—Taurus 16MT

L2—Taurus 16MT In the above case server 101 may look for L1 rate for a particular route and then match to look vehicle sub type with equal to order sub type vehicle. In case vehicle is available, the server 101 will match the vehicle and mark off both the order and the vehicle. In case the vehicle is not available of matching type, the order is kept as unassigned and server 101 shall proceed to process the next order as outlined in previous steps from by PTC to age of vehicle based on RC date. In such way, the server 101 shall complete the allocation of vehicle in the selected PTC by matching vehicles sub type as defined in order and available vehicle. After completing the process of assigning orders as defined in above steps, server 101 may proceed to unassigned order and match them with vehicle of higher capacity. In such process, rate score of the channel partner may be considered first and there after vehicle sub type of higher capacity. The assigning of order shall be completed for higher ranking vehicle capacity explained in above allocation process. In another embodiment, if vehicle of higher ranking capacity is not available, server 101 should proceed as unassigned and complete allocations of orders of selected PTC for higher capacity vehicle. After completion of assigning orders to vehicle of higher capacity, the server 101 shall take into account of all unassigned orders and start matching them with vehicles of lower capacity within that specified in order. The channel partner rate and score shall be taken first and order to vehicle shall be completed specified in steps of allocation process mentioned above.

In such manner, the server 101 may complete assigning of all orders and vehicle of selected PTC and may then proceed to do allocations of the next PTC within the cluster. The allocation process of the next selected PTC may be completed as specified in in the allocation process mentioned above as well as other steps for unassigned orders. In such manner assigning of orders and allocation of vehicles may be completed for all PTC's of the relevant cluster. Such cluster transport centered allocation of vehicles is explained in the further embodiments.

In an embodiment, after completing of all steps of the allocation process, the server 101 may consider all unassigned orders and unassigned vehicles within the cluster in allocation process. After completion of assignment of orders and allocation of vehicles, in case there are any unassigned vehicles or orders, then these unassigned vehicles or orders may be carried forward to next bidding cycle. In case after the conclusion of all the bidding cycle of the day then any vehicle remains unassigned, the system shall mark such vehicle as Idle Vehicle for Idle Vehicle Reimbursement Charges.

In another embodiment, a vehicle may be assigned to only a single order at a time. If a channel partner is L1 at multiple destinations, then the vehicle may be assigned on the basis of the route for which the channel partner bid first. The system may store initial time of bidding, last time of bidding and last bidding amount. All parameters of bidding being equal, if there are two channel partners, both of whom are L1, then the channel partner who quoted first for the load to become L1 may be given preference. The server 101 may assign a derived scoring level based on the time of quote/bid and use this derived scoring level for the allocation of Vehicle. In case two or more Vehicles of a channel partner are L1, for any given destination, then the Vehicle which has history (city/surrounded area and not exact consignee location) of having travelled on this route in the past may be given preference. In case two or more vehicles have the same history of travelling on the route, then the Vehicle with more no of trips may be given precedence. In case two or more vehicles have same history and same no of trips, the vehicle with lower age (based on RC date) may be given preference in the allocation of vehicle.

In an embodiment, the system allocates a vehicle for executing a logistic order based on cluster transport center logic. The cluster transport center may comprise a plurality of Primary Transport Centre with a predefined distance difference between them. The cluster may be formed based on the distance between the primary transport centers. The cluster transport logic may enable an idle vehicle (which is placed at PTC 1) to execute a logistic order which is to be executed from PTC 2 (which has an order but no vehicle is idle to assign the logistic order) to PTC 3 wherein PTC 2 is near to PTC 1 and which is an eligible cluster center according to the predefined distance difference. The feature of the cluster transport centre may eliminate or terminate the idle position of a vehicle at a PTC belonging to a cluster. The example of cluster transport center is explained as following: Consider a vehicle which is idle at PTC: Vapi and the said vehicle is in an idle position and is not assigned any logistic order. A cluster of PTCs is formed based on a minimum distance between the PTC as less than 100 kms. or as per the predefined distance difference, set in system parameter file. PTC Surat falls under the cluster and an active logistic order from Surat to Mumbai part of PTC Surat is to be assigned and further PTC Surat is not equipped with any idle vehicle to assign the logistic order. As per the cluster transport center logic, the system will assign Surat to Mumbai order to the vehicle which is idle at Vapi. This logic will make the idle vehicle at Vapi to a status of engaged/busy vehicle.

Although implementations for system and method for assigning logistic order to consignor based on reverse bidding have been described in language specific to structural features and/or methods, it is to be understood that the appended claims are not necessarily limited to the specific features or methods described. Rather, the specific features and methods are disclosed as examples of implementations for assigning logistic order to consignor based on reverse bidding.

1. A method for assigning logistic orders of a consignor to a channel partners for transferring a load associated to the logistic orders from the consignor to a consignee, the method comprising:
registering, via a processor, a plurality of consignors, a plurality of consignees and a plurality of channel partners in a memory of a system;
receiving, via the processor, one or more logistic orders along with metadata associated with the one or more logistic orders from a consignor;
notifying, via the processor, the one or more logistic orders to one or more channel partners matching with the metadata associated with the one or more logistic orders;
receiving, via the processor, a bid comprising an initial bid amount from each of the one or more channel partners to execute the one or more logistic orders;
assigning, via the processor, an initial score to each of the one or more channel partners based upon the initial bid amount in the bid and a time of bidding by each of the one or more channel partners;
updating, via the processor, the initial bid amount to a revised bid amount in the bid of each of the based upon predefined set of rules;
modifying, via the processor, the initial score of each of the one or more channel partners to a final score based upon the revised bid amount;
sorting, via the processor, the one or more channel partners in an order of the final score assigned to each of the one or more channel partners;
displaying, via the processor, bid details associated with each of the one or more channel partner in the sorted order, wherein the bid details comprises a channel partner, the final score and the revised bid amount; and
assigning, via the processor, a channel partner having the highest final score for executing the one or more logistic orders.

2. The method of claim 1, wherein the logistic orders are received from a registered and approved consignor and further ensured whether the consignor is not blacklisted or inactive.

3. The method of claim 1, wherein the plurality of logistic orders placed in a time slot will only be allotted for bidding process in an upcoming time-slot.

4. The method of claim 1, wherein one or more channel partners will be assigned with the initial score, wherein the initial score is provided to that order with minimum bid value and the scores are prioritised to dedicated channel providers.

5. The method of claim 1, wherein the metadata comprises type of the vehicle, permit type associated to the vehicle, number of vehicles required, rate per vehicle in case of bidding by order and bid per vehicle in case bidding by vehicle, a base price for the bidding, and certificates and other documents for verification.

6. The method of claim 5, wherein the certificates and other documents for verification comprises registration certificate book of vehicle, pollution unit control, type of transport permit, insurance validity and vehicle fitness certificate.

7. The method of claim 1, wherein the selection of vehicles is based on the tonnage capacity with a range of −3 tonnage capacity to +2 tonnage capacity in consideration of the required tonnage capacity.

8. The method of claim 1, wherein an idle vehicle present at primary transport centre belonging to transport centre cluster is assigned for a logistic order which is executed between two or more primary transport centres other than the primary transport centre where the vehicle is idle and the primary transport centre which will be a starting point for that order belongs to the transport centre cluster.

9. A system for assigning logistic orders of a consignor to a channel partners to transfer a load associated to the order from a consignor to a consignee, the system comprising:
a processor; and
a memory coupled with the processor, wherein the processor executes a plurality of modules stored in the memory, the plurality of modules comprising:
a registering module enabled for registering of a plurality of consignors, consignees and channel partners in the memory of the system;
a logistic order placing module enabled placing one or more logistic orders along with metadata associated with the one or more logistic orders from a consignor;
a notifying module enabled for notifying the one or more logistic orders to one or more channel partners matching with the metadata associated with the one or more logistic orders;
a bidding module enabled for receiving a bid comprising an initial bid amount from each of the one or more channel partners to execute the one or more logistic orders
a bid analysing module enabled for
assigning an initial score to each of the one or more channel partners based upon the initial bid amount in the bid and a time of bidding by each of the one or more channel partners;
updating the initial bid amount to a revised bid amount in the bid of each of the based upon predefined set of rules;
modifying the initial score of each of the one or more channel partners to a final score based upon the revised bid amount;
sorting, via the processor, the one or more channel partner in an order of the final score assigned to each of the one or more channel partner; and
displaying bid details associated with each of the one or more channel partners in the sorted order, wherein the bid details comprises a channel partner, the final score and the revised bid amount; and
an assigning module enabled for assigning a channel partner having the highest final score for executing the one or more logistic orders.

10. The system of claim 9, wherein the metadata comprises number of vehicles required, rate per vehicle in case of bidding by order and bid per vehicle in case bidding by vehicle and certificates and other documents for verification.

11. The system of claim 10, wherein the wherein the certificates and other documents for verification comprises registration certificate book of vehicle, pollution unit control, type of transport permit, insurance validity and vehicle fitness certificate.

12. The system of claim 9, wherein an idle vehicle present at primary transport centre belonging to transport centre cluster is assigned for a logistic order which is executed between two or more primary transport centres other than the primary transport centre where the vehicle is idle and the primary transport centre which will be a starting point for that order belongs to the transport centre cluster.

13. A non-transitory computer readable medium storing program for assigning logistic orders of a consignor to a channel partner to transfer a load associated to the order from a consignor to a consignee, the program comprising instructions for:
registering a plurality of consignors, a plurality of consignees and a plurality of channel partner in a memory of a system;
receiving one or more logistic orders along with metadata associated with the one or more logistic orders from a consignor;
notifying the one or more logistic orders to one or more channel partner matching with the metadata associated with the one or more logistic orders wherein the one or more predefined parameters comprises permit type associated to the vehicle;
receiving a bid comprising an initial bid amount from each of the one or more channel partner to execute the one or more logistic orders;
assigning an initial score to each of the one or more channel partner based upon the initial bid amount in the bid and a time of bidding by each of the one or more channel partners;
updating the initial bid amount to a revised bid amount in the bid of each of the based upon predefined set of rules;
modifying the initial score of each of the one or more channel partner to a final score based upon the revised bid amount;
sorting the one or more channel partners in an order of the final score assigned to each of the one or more channel partners; and
displaying bid details associated with each of the one or more channel partner in the sorted order, wherein the bid details comprises a channel partner, the final score and the revised bid amount; and
assigning a channel partners having the highest final score for executing the one or more logistic orders.
